(19) United States
(12) Patent Application Publication
(10) Pub. No.: US 2026/0079995 A1
(43) Pub. Date: Mar. 19, 2026

(54) METHOD AND ELECTRONIC DEVICE FOR PROCESSING USER REVIEW INFORMATION OF PRODUCT OBJECT

(71) Applicant: Hangzhou Alibaba International Internet Industry Co., Ltd., Hangzhou (CN)

(72) Inventors: Zhenfang WU, Hangzhou (CN); Yong AN, Madrid (ES); Kezheng LIAO, Hangzhou (CN); Quan GUO, ShenZhen City (CN)

(21) Appl. No.: 19/402,647

(22) Filed: Nov. 26, 2025

Related U.S. Application Data
(63) Continuation of application No. PCT/CN2024/079463, filed on Feb. 29, 2024.

(30) Foreign Application Priority Data
May 31, 2023 (CN) 202310641306.4

(51) Int. Cl. G06F 16/34; G06Q 30/0282

(52) U.S. Cl. CPC G06F 16/345; G06Q 30/0282

(57) ABSTRACT

Embodiments of the present application disclose a method for processing user review information of a product object, and an electronic device. The method includes: in response to a request from a target user to view user review for a target product, generating target text content by inputting a plurality of user reviews associated with the target product into a target algorithm model for processing, where the target text content is used for providing a summarizing description of the plurality of user reviews; and returning the target text content to a client, so as to display the target text content when displaying the user review information. Through embodiments of the present application, it is possible to help a user more efficiently achieve a more complete and comprehensive understanding of user review, thereby enabling the user review to more effectively help the user make purchasing decisions.

### CROSS-REFERENCE TO RELATED APPLICATION

This application is a Continuation Application of International Patent Application No. PCT/CN2024/079463, filed on February 29, 2024, which is based on and claims priority to and benefits of Chinese Patent Application No. 202310641306.4, filed with the China National Intellectual Property Administration on May 31, 2023, and entitled "Method and Electronic Device for Processing User Review Information of Product Object." The entire content of the above-referenced applications is incorporated herein by reference.

### TECHNICAL FIELD

The present application relates to the field of information processing technologies, and in particular, to a method for processing user review information of a product object, and an electronic device.

### BACKGROUND

During the process where a user browses and selects products through a product information service system, review information published by other users for the products usually has very important reference value in aspects such as helping the user make shopping decisions. For example, after a user browses the detailed information of a product, if the user is relatively interested, the user may make further decisions by viewing user reviews, and so on. However, in practical applications, for some popular products or products with high sales volumes, the number of user review items may be relatively large, and the user may need to spend a long time viewing them. Therefore, the user may often exit or close after viewing a few items. This may lead to the user forming a one-sided impression of the product due to not having viewed the complete review, or some reviews that is truly useful to the current user may not be seen by the user because it is ranked in a relatively lower position, thus failing to play its true role in helping the user make shopping decisions, and so on. Therefore, how to help a user improve the efficiency of viewing user reviews and obtain more accurate and comprehensive information about the user reviews has become a technical problem to be solved by a person skilled in the art.

### SUMMARY

The present application provides a method and an electronic device for processing user review information of a product object, which can help a user more efficiently achieve a more complete and comprehensive understanding of user reviews, thereby enabling the user reviews to more effectively help the user make shopping decisions.

The present application provides the following solutions:

A method for processing user review information of a product object, comprising:

in response to a request from a target user to view user reviews of a target product, generating target text content by inputting a plurality of user reviews associated with the target product into a target algorithm model for processing, wherein the target text content is used for providing a summarizing description of the plurality of user reviews;

returning the target text content to a client, so as to display the target text content when displaying the user review information.

Specifically, generating the target text content by inputting the plurality of user reviews associated with the target product into the target algorithm model for processing comprises:

acquiring sentiment type information expressed by the user reviews, information on advantages and disadvantages of the target product, information on commonalities or similarities existing between different user reviews, and/or matching relationship information between the target product and needs/preferences of the target user, by inputting the plurality of user reviews associated with the target product into the target algorithm model for processing;

generating the target text content by processing the acquired information.

Specifically, generating the target text content by inputting the plurality of user reviews associated with the target product into the target algorithm model for processing comprises:

generating the target text content by inputting the plurality of user reviews associated with the target product and personalized information of the target user into the target algorithm model for processing.

A method for processing user review information of a product object, comprising:

receiving a request from a target user to view user reviews of a target product;

displaying a user review display page, wherein the user review display page includes target text content, the target text content is generated by inputting a plurality of user reviews associated with the target product into a target algorithm model for processing, and is used for providing a summarizing description of the plurality of user reviews.

Specifically, the method further comprises:

before displaying the target text content, providing an interactive option on the user review display page, so that a user can confirm whether to display the target text content, and after a confirmation message is received, triggering display of the target text content.

A method for processing user review information of a product object, comprising:

in response to a request initiated by a target user to fill in user review information for a target product object, acquiring a basic review provided by the target user for the target product object;

submitting the basic review to a server, and acquiring target text content for display, wherein the target text content is text content generated by the server by inputting the basic review into a target algorithm model for processing, so as to determine review body content for publishing based on the target text content.

Specifically, the basic review comprises sentiment type information expressed by the target user for the target product.

Specifically, the basic review comprises rating information input or selected by the target user for the target product object through a plurality of rating items displayed on a user review editing interface.

Specifically, the basic review further comprises review body content input by the target user for the target product through the user review editing interface.

Specifically, the method further comprises:

after the target text content is displayed, in response to a refresh request for the target text content, re-acquiring new target text content and displaying it.

Specifically, the method further comprises:

after the target text content is displayed, in response to a request to use the target text content, displaying the target text content in an input control used for inputting review body content, so as to determine the review body content based on the target text content and publish it.

A method for processing user review information of a product object, comprising:

in response to a request to assist in generating review body content, acquiring a basic review submitted by a target user for a target product;

generating target text content by inputting the basic review into a target algorithm model for processing;

returning the target text content to a client, so as to determine review body content for publishing based on the target text content.

An apparatus for processing user review information of a product object, comprising:

a target text content generation unit, configured to, in response to a request from a target user to view user reviews of a target product, generate target text content by inputting a plurality of user reviews associated with the target product into a target algorithm model for processing, wherein the target text content is used for providing a summarizing description of the plurality of user reviews;

a target text content returning unit, configured to return the target text content to a client, so as to display the target text content when displaying the user review information.

An apparatus for processing user review information of a product object, comprising:

a request receiving unit, configured to receive a request from a target user to view user reviews of a target product;

a display unit, configured to display a user review display page, wherein the user review display page includes target text content, the target text content is generated by inputting a plurality of user reviews associated with the target product into a target algorithm model for processing, and is used for providing a summarizing description of the plurality of user reviews.

An apparatus for processing user review information of a product object, comprising:

a basic review receiving unit, configured to, in response to a request initiated by a target user to fill in user review information for a target product object, acquire a basic review provided by the target user for the target product object;

a target text content display unit, configured to submit the basic review to a server, and acquire target text content for display, wherein the target text content is text content generated by the server by inputting the basic review into a target algorithm model for processing, so as to determine review body content for publishing based on the target text content.

An apparatus for processing user review information of a product object, comprising:

a basic review acquisition unit, configured to, in response to a request to assist in generating user review body content, acquire a basic review submitted by a target user for a target product;

a target text content generation unit, configured to generate target text content by inputting the basic review into a target algorithm model for processing;

a target text content returning unit, configured to return the target text content to a client, so as to determine review body content for publishing based on the target text content.

A non-transitory computer-readable storage medium, on which a computer program is stored, wherein the program, when executed by a processor, implements the steps of the method according to any one of the foregoing.

An electronic device, comprising:

one or more processors; and

a memory associated with the one or more processors, the memory being used for storing program instructions, wherein the program instructions, when read and executed by the one or more processors, execute the steps of the method according to any one of the foregoing.

According to specific embodiments provided by the present application, the present application discloses the following technical effects.

Through embodiments of the present application, when a user needs to view user reviews of a certain target product, and the target product is associated with a plurality of user reviews, target text content used for providing a summarizing description of the plurality of user reviews can be produced by inputting the plurality of user reviews into a target algorithm model for processing, and this target text content is displayed to the user. In this way, the user only needs to view this model-produced target text content to understand the overall reviews of the current product by other users. Therefore, it enables the user to more efficiently achieve a more complete and comprehensive understanding of the user reviews, thereby enabling the user reviews to more effectively help the user make shopping decisions.

In addition, when a user needs to review a certain product object, capabilities such as an AI large-scale model can be utilized to generate target text content based on basic review input by the user. In this way, the user can complete the input of the review body content based on this target text content. Thus, the user does not need to spend a lot of time thinking about how to write the review, nor does the user need to input a very long review body content word by word. Therefore, it can help the user improve efficiency and reduce the user's time cost. In addition, for the platform, because the target text content generated by the model may be fuller and richer in content, it is conducive to improving the quality of user reviews, providing more valuable reference information for more users, and in turn is also conducive to enhancing users' sense of trust and satisfaction with the platform.

Certainly, any product implementing the present application does not necessarily need to achieve all the above-mentioned advantages at the same time.

### BRIEF DESCRIPTION OF DRAWINGS

In order to more clearly explain the technical solutions in the embodiments of the present application or in the prior art, the accompanying drawings required for use in the embodiments will be briefly introduced below. It is obvious that the accompanying drawings in the following description are only some embodiments of the present application, and for a person of ordinary skill in the art, other drawings can also be obtained from these accompanying drawings without creative effort.

FIG. 1 is a schematic diagram of a system architecture provided in an embodiment of the present application;

FIG. 2 is a flowchart of a first method provided in an embodiment of the present application;

FIG. 3 is a schematic diagram of a first interface provided in an embodiment of the present application;

FIG. 4 is a flowchart of a second method provided in an embodiment of the present application;

FIG. 5 is a flowchart of a third method provided in an embodiment of the present application;

FIG. 6 is a schematic diagram of a second interface provided in an embodiment of the present application;

FIG. 7 is a schematic diagram of a third interface provided in an embodiment of the present application;

FIG. 8 is a flowchart of a fourth method provided in an embodiment of the present application;

FIG. 9 is a schematic diagram of a first apparatus provided in an embodiment of the present application;

FIG. 10 is a schematic diagram of a second apparatus provided in an embodiment of the present application;

FIG. 11 is a schematic diagram of a third apparatus provided in an embodiment of the present application;

FIG. 12 is a schematic diagram of a fourth apparatus provided in an embodiment of the present application;

FIG. 13 is a schematic diagram of an electronic device provided in an embodiment of the present application.

### DETAILED DESCRIPTION OF EMBODIMENTS

The technical solutions in the embodiments of the present application will be clearly and completely described below with reference to the accompanying drawings in the embodiments of the present application. It is apparent that the described embodiments are only a part of the embodiments of the present application, rather than all of the embodiments. Based on the embodiments in the present application, all other embodiments obtained by a person of ordinary skill in the art without creative effort shall fall within the protection scope of the present application.

In order to help a user improve the browsing efficiency of user reviews for products, and at the same time, in the case where the number of user review items is relatively large, also be able to achieve a more comprehensive and complete understanding of this kind of user reviews in a short time, embodiments of the present application can apply the capabilities of an AI (Artificial Intelligence) large-scale parameter model (referred to as "AI large-scale model") to the scenario of helping a user view user reviews of products. In particular, the so-called AI large-scale model refers to a model pre-trained on a large-scale dataset containing a huge amount of data using a neural network model. This type of model usually has powerful model understanding capabilities for text information, image information, etc., and also has content production capabilities. The specifically produced content can include text, images, video, voice, and so on. Because this AI large-scale model has powerful model understanding capabilities, it has been applied in many fields. From this perspective, embodiments of the present application can belong to the application of this AI large-scale model in scenarios related to the display of user reviews of product objects.

Specifically, in an embodiment of the present application, when a user needs to view the user reviews of a certain target product, the AI large-scale model described above can be used to perform model understanding on a plurality of user reviews associated with the target product. Based on the model understanding results, the plurality of user reviews can be summarized, and the AI large-scale model can produce target text content used for providing a summarizing description of the plurality of user reviews. For example, it can identify and summarize sentiment description information such as users' positive reviews, negative reviews, or neutral reviews of the product; or, it can also identify and summarize information such as the characteristics, advantages, and disadvantages of the product mentioned by users in the reviews; or, it can also perform commonality or similarity analysis on the plurality of user reviews to perform classification and summarization. Furthermore, it can also perform summarization in aspects such as the matching relationship with the user's preferences based on the current target user's preferences or some basic attributes (including the population group to which the user belongs), and so on. In short, one or more paragraphs of summarizing text content can be generated, and the text content within each paragraph can be a coherent expression that conforms to natural language grammar, so as to be easy for the user to understand. By providing and displaying the target text content to the user, the user can quickly browse the user reviews through the target text content. Moreover, because it has the nature of summarization, after seeing the target text content, it is equivalent to having read all the user reviews and drawn a conclusion. In this way, it can help the user improve the browsing efficiency of the user reviews and achieve a more complete and comprehensive understanding of the user reviews, which in turn can better play a role in helping the user make purchasing decisions.

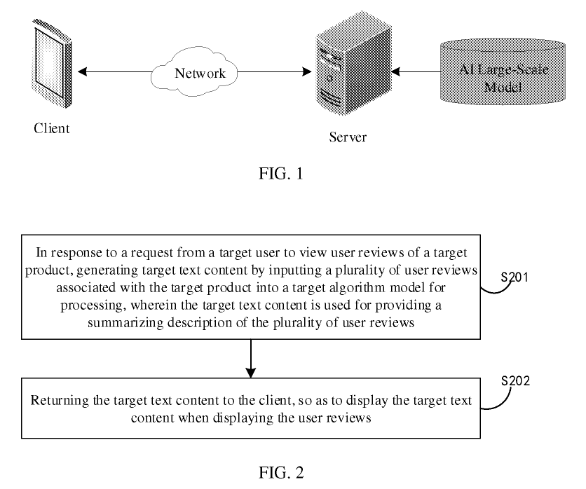

From a system architecture perspective, embodiments of the present application can provide the above functions in a product information service system. Specifically, referring to FIG. 1, a specific system can include a client and a server. In particular, the client can exist in the form of an application (App) or a Web, H5, or other page, and mainly runs on a user's terminal device, including mobile terminal devices such as mobile phones. The server mainly runs in a server, which can specifically include a cloud server or an independent server, and so on. In particular, the client is mainly used for front-end page display and interaction with the user, while the server can provide specific data services. In embodiments of the present application, it can specifically invoke an AI large-scale model or the like to achieve summarization and conclusion of a plurality of user reviews and generate text content to be returned to the client for display, and so on.

The specific implementation solutions provided by the embodiments of the present application are described in detail below.

### Embodiment One

First, this Embodiment One provides a method for processing user review information of a product object from the perspective of a server. Referring to FIG. 2, the method may include:

S201: In response to a request from a target user to view user reviews of a target product, generating target text content by inputting a plurality of user reviews associated with the target product into a target algorithm model for processing, wherein the target text content is used for providing a summarizing description of the plurality of user reviews.

Specifically, the target product may be a product that the user is currently browsing. Usually, on a product details page, a "Review" information card can be provided. In a default state, this information card can display summary information about some user reviews, for example, usually displayed as one or two items. After the user clicks on this information card, a specific user review details page can be displayed, and the complete user review can be viewed through this page. However, as described in the background art section, for some product objects, the number of corresponding user review items may be very large. At this time, the user needs to scroll through multiple screens to view them, and the user often may no longer have the patience to continue viewing after several screens, resulting in the inability to obtain relevant reference information from the content that has not been displayed at the back.

In an embodiment of the present application, after the user initiates a request to view the user reviews of a product, the server can also invoke a target algorithm model (for example, the aforementioned AI large-scale model, etc., which is mainly used as an example for introduction in this specification). In this way, the AI large-scale model can convert the plurality of user reviews associated with the target product into the model's understanding, and then can produce target text content by summarizing the user reviews. That is to say, just like someone has finished reading all the user reviews and drawn a conclusion, the AI large-scale model can "read" all the user reviews on behalf of the user, and directly provide the conclusion drawn after this reading to the user.

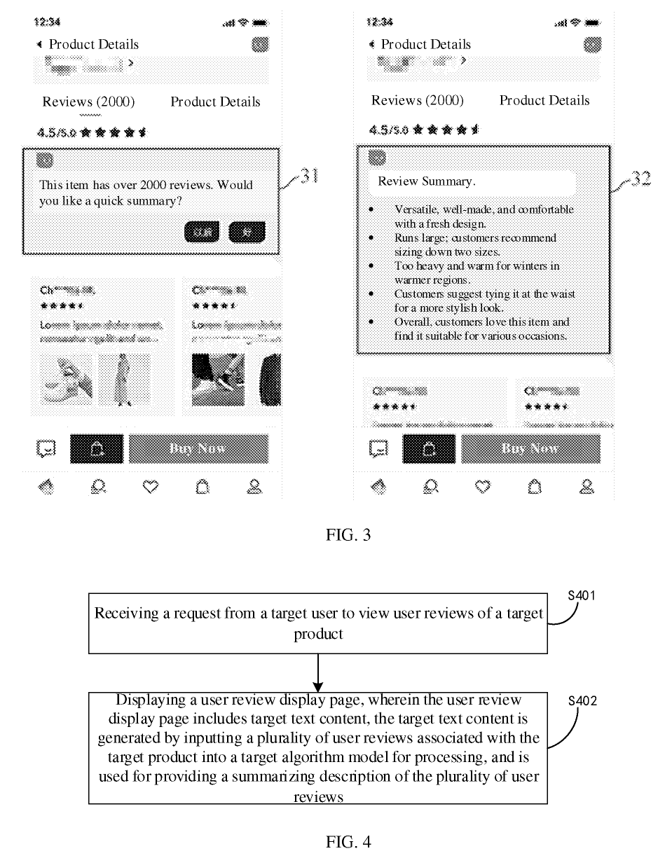

Of course, in specific implementations, in order to avoid interfering with the user's viewing of user reviews in a normal mode, a method of having the user confirm whether to view this model-produced content can also be adopted. After the user confirms, the generation and display of the above-mentioned target text content are then performed. For example, in a specific implementation, as shown in FIG. 3(A), at the top or other position of the user review display page, "This product has 2000+ user reviews, would you like me to help you browse them quickly?" can be displayed, and options such as "Later" and "OK" can be provided to the user. After the user selects "OK", the generation of the above-mentioned target text content is then performed, and so on.

Specifically, during the process of model understanding of the plurality of user reviews associated with the target product, information from multiple aspects can be acquired. For example, sentiment type information expressed by the user reviews (including judgments about positive, negative, or neutral reviews), information on the advantages and disadvantages of the target product, information on commonalities or similarities existing between different user reviews, and/or matching relationship information between the target product and the needs/preferences of the target user, etc., can be specifically acquired. When specifically generating the target text content, a whole paragraph of text content can be generated, or, summarization and conclusion can be performed separately from multiple aspects or angles to generate multiple paragraphs of text content, and so on.

It should be noted here that, specifically when performing model understanding of the user review, because the user reviews submitted by the user may include scoring information for some rating items, review body content information input by the user, and may also include image content such as photos of the actual received product, the product, etc., uploaded by the user, and so on, therefore, the specific model understanding process can be a model understanding of the above-mentioned multi-modal information. In this way, through the fusion of this multi-modal information, it is conducive to obtaining more accurate summarization and conclusion results, and at the same time, it can also reduce or eliminate the influence of some user reviews with inaccurate descriptions. For example, suppose that in a certain user review, the review body content describes the on-body effect of the product relatively well, but from the on-body effect picture uploaded by the user, the effect is not very good. Therefore, when generating the specific target text content, this review body content and the on-body effect picture can be comprehensively considered to give a more appropriate conclusion, and so on.

In addition, when generating the above-mentioned target text content, it can also be generated in combination with the personalized information of the current target user. In particular, the specific personalized information can include points that the user pays more attention to when selecting products. For example, for the same clothing-type product, some users may be more concerned about fabric comfort, some users may be more concerned about price, and some users may be more concerned about quality, and so on. Therefore, according to the different points of concern of the user, personalized processing can also be performed when generating the above-mentioned target text content. For example, for a user who is concerned about fabric comfort, the fabric characteristics, content about comfort in user reviews, etc., can be introduced more or with priority, and so on. In addition, because the same product object may be suitable for some population groups but not very suitable for other population groups, this personalized information can also include information such as the population group to which the current user belongs. For example, this population group can be divided according to location, occupation, skin type, etc. In this way, when generating the specific target text content, the focus can be on summarizing the reviews provided by users who belong to the same or similar population groups as the current user. For example, for a down jacket-type product, from the user reviews, it may be found that it is more suitable for wearing in colder places in the north, and may be a bit too heavy for users in the south. At this time, if the current user happens to be a user from the south, this information can be reflected when generating the target text content, for example: "This jacket has a high down filling amount and good warmth, but it might be a bit too thick for girls in the south." As another example, for a cosmetic-type product, from the user reviews, users with dry skin generally give better reviews, but users with oily skin generally give poor feedback. If the current user happens to have dry skin, then when generating the above- mentioned target text content, it can include: "Good moisturizing effect, suitable for those with dry skin," and so on.

S202: Returning the target text content to the client, so as to display the target text content when displaying the user review information.

After the specific target text content is generated, it can be provided to the client. In this way, the client can display this target text content on the user review display page. For example, as shown in FIG. 3(B), the target text content produced for the current product can be displayed, which can include a total of five paragraphs, summarizing the user reviews from five aspects, and so on. In this way, the user can more efficiently and quickly understand the reviews of the current product by other users, thereby enabling the user reviews to more effectively help the user make shopping decisions.

In summary, through this embodiment of the present application, when a user needs to view the user reviews of a certain target product, and the target product is associated with a plurality of user reviews, model understanding can be performed on the plurality of user reviews to produce target text content used for providing a summarizing description of the plurality of user reviews, and this target text content is displayed to the user. In this way, the user only needs to view this model-produced target text content to understand the overall reviews of the current product by other users. Therefore, it enables the user to more efficiently achieve a more complete and comprehensive understanding of the user reviews, thereby enabling the user reviews to more effectively help the user make shopping decisions.

### Embodiment Two

This Embodiment Two corresponds to Embodiment One and provides a method for processing user review information of a product object from the perspective of a client. Referring to FIG. 4, the method may include:

S401: Receiving a request from a target user to view user reviews of a target product;

S402: Displaying a user review display page, wherein the user review display page includes target text content, the target text content is generated by inputting a plurality of user reviews associated with the target product into a target algorithm model for processing, and is used for providing a summarizing description of the plurality of user reviews.

Specifically, before displaying the target text content, an interactive option can also be provided on the user review display page, so that the user can confirm whether to display the target text content, and after a confirmation message is received, the display of the target text content is triggered.

For the undetailed content in this Embodiment Two, reference can be made to the descriptions in the foregoing Embodiment One and other parts of this specification, which will not be repeated here.

### Embodiment Three

The above Embodiments One and Two are for when a user needs to view user reviews about a certain product, the capabilities of an AI large-scale model can be used to summarize the user reviews and produce target text content to be provided to the user for reference. In addition, in practical applications, there is also a situation where, when users publish reviews for products they have already purchased, due to limited expressive ability or not wanting to spend too much time, they may only score some mandatory rating items, and the review body part may be written very simply, so that this type of reviews may be difficult to provide effective reference for other users. For the platform side, it usually encourages users to describe their feelings about using the product as detailed and specific as possible, which will have a positive effect on enhancing users' trust in the platform and other aspects. Therefore, in Embodiment Three of the present application, the capabilities of an AI large-scale model can also be used to help users complete the input of user reviews for specific products, thereby producing higher-quality user reviews while occupying less of the user's time, and at the same time reducing the dependence on the user's personal language expression ability.

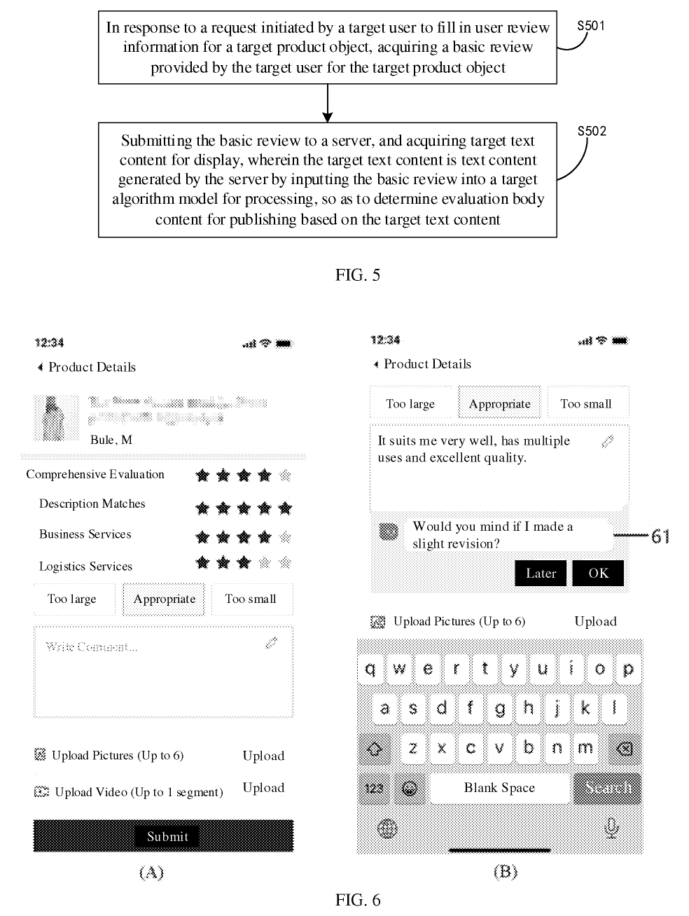

Specifically, this Embodiment Three first provides a method for processing user review information of a product object from the perspective of a client. Referring to FIG. 5, the method may specifically include:

S501: In response to a request initiated by a target user to fill in user review information for a target product object, acquiring a basic review provided by the target user for the target product object.

After placing an order for a certain product and performing a confirm receipt operation, a product review option can usually be provided to the user. The user can enter the interface for filling in user review information for the product through this option, that is, the user review editing interface described in this document.

On this user review editing interface, the system usually also provides some rating items for the user to score. For example, as shown in FIG. 6(A), the specific rating items can include description conformity (that is, whether the actual product is consistent with the information described on the product details page, or the degree of conformity), merchant service (which can usually refer to the merchant's shipping speed, etc.), logistics service (which can usually refer to the efficiency of logistics delivery, etc.), and other aspects. The user can score according to the actual experience results. For example, multiple score levels can be provided for each rating item, and the user can choose to give a certain score level to a specific rating item. The higher the score level a rating item receives, the higher the score, and the higher the user's satisfaction with that rating item, and so on. In addition, on the above-mentioned editing interface, an option for providing a "comprehensive review" can also be provided to the user. Through this option, the user can give options for expressing sentiment types such as "positive review," "neutral review," "negative review" for the specific product object, and the user can make a choice through this option. Furthermore, on the above-mentioned editing interface, an input box for inputting review body content can usually also be provided to the user. In addition to scoring the above-mentioned rating items, the user can also input specific review body content.

Therefore, in an embodiment of the application, the so-called basic review can include the above-mentioned scoring result information for a plurality of rating items, so that the AI large-scale model can generate text content based on this rating information. Alternatively, the specific basic review can also be simple information about sentiment type description, including positive review, neutral review, negative review, etc. Alternatively, the specific basic review can also include review body content input by the user, etc. In this way, the AI large-scale model can further produce text content on the basis of the rating information of specific rating items, sentiment type information, and/or the review body content already input by the user.

S502: Submitting the basic review to a server, and acquiring target text content for display, wherein the target text content is text content generated by the server by inputting the basic review into a target algorithm model for processing, so as to determine review body content for publishing based on the target text content.

After receiving the above-mentioned basic review, an AI large-scale model or the like can assist in generating a paragraph of text content based on this basic review input by the user. That is to say, the user can just give sentiment type information such as a positive or negative review for the target product, or score some rating items, and then the AI large-scale model assists in generating a paragraph of text content to be used as the review body content or as a reference. Alternatively, after simply filling in some review body content, the AI large-scale model can assist in rewriting it, so that the actually published review body content is fuller and can bring more reference value to other users, while not causing excessive occupation of the user's time cost, and so on.

Certainly, in specific implementations, in order to avoid interfering with the process of the user actually inputting the user review, the above-mentioned process of generating the target text content can be performed after receiving a confirmation operation from the user. That is to say, an operation option for inquiring the user can be provided on the above-mentioned editing interface. For example, as shown at 61 in FIG. 6(B), dialogue content such as "Would you like me to rewrite it a little?" can be provided on the editing interface, and options such as "Later" and "OK" can be provided. If the user selects "OK", it means that the user confirms the need for the AI large-scale model to help with rewriting. Thereafter, a step of generating the target text content can be triggered.

In the above manner, the user may first enter the user review editing interface through a "Review" entry provided for a specific order/product object in a page such as an order list, and after providing some basic reviews, initiate a request for AI-assisted generation of review through an operation option in the user review editing interface. Alternatively, in another manner, to further improve efficiency, while providing the "Review" entry in a page such as the order list page, operation options for expressing a sentiment type, such as "Positive review" and "Negative review," may be directly provided. Or, operation options for scoring rating items may also be directly provided. In this way, the user can directly make a simple basic review through the operation option and then trigger the AI-assisted generation of review, without needing to enter the user review editing interface to trigger it, thereby allowing the user to more efficiently acquire the AI-assisted generated user review, and so on.

Specifically, when generating the target text content, it can be generated by a large AI model or the like after performing model understanding on the basic review already inputted by the user. Of course, during the generation process, some descriptive information of the product itself can also be incorporated. In addition, when generating the specific target text content, the user's customary expression styles, modal particles, etc., can be simulated based on user reviews historically inputted by the user, so that the generated target text content is more likely to be accepted by the user, and so on.

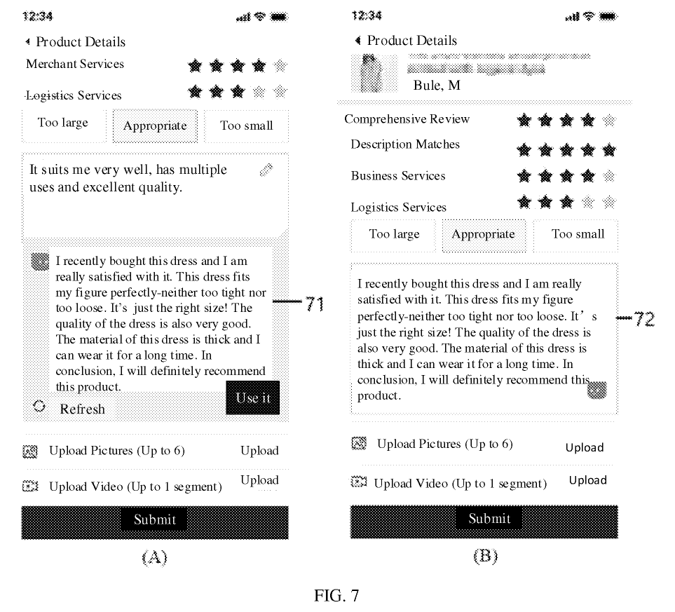

After the target text content is generated, it can be displayed in the aforementioned editing interface. For example, as shown at 71 in FIG. 7(A), when the review body content inputted by the user is "Very suitable for me, versatile, and high quality," it can be rewritten by the large AI model into: "I recently bought this dress, and I'm really satisfied with it. This dress fits my figure perfectly—not too tight and not too loose, this dress is just right! The quality of the dress is also very good. The material of this dress is very thick, and I can wear it for a long time. All in all, I would definitely recommend this product."

After the target text content is displayed, options such as "Refresh" and "Use it" can also be provided to the user. If the user is not satisfied with the currently generated target text content, the user can select the "Refresh" option, at which time the model can regenerate the target text content. If "Use it" is selected, the target text content can be displayed in the input control for inputting the review body content, so as to determine the review body content based on the target text content and publish it. For example, assuming the user clicks the "Use it" option for the target text content shown in FIG. 7(A), then as shown at 72 in FIG. 7(B), the text content will be filled into the input box in the interface, replacing the review body content previously inputted by the user. Of course, the user can also use the input box to perform some editing and polishing of the target text content, and so on, before submitting.

Through this Embodiment Three, when a user needs to review a certain product object, capabilities such as a large AI model can be utilized to generate target text content based on the basic review inputted by the user. In this way, the user can complete the input of the review body content based on this target text content. Thus, the user does not need to spend a lot of time thinking about how to write the review, nor does the user need to input long review body content word by word. Therefore, it can help the user improve efficiency and reduce the consumption of the user's time. In addition, for the platform, because the target text content generated by the model may be fuller and richer in content, it is conducive to improving the quality of user reviews and providing more valuable reference information for more users, which in turn is also conducive to enhancing users' sense of trust and satisfaction with the platform.

### Embodiment Four

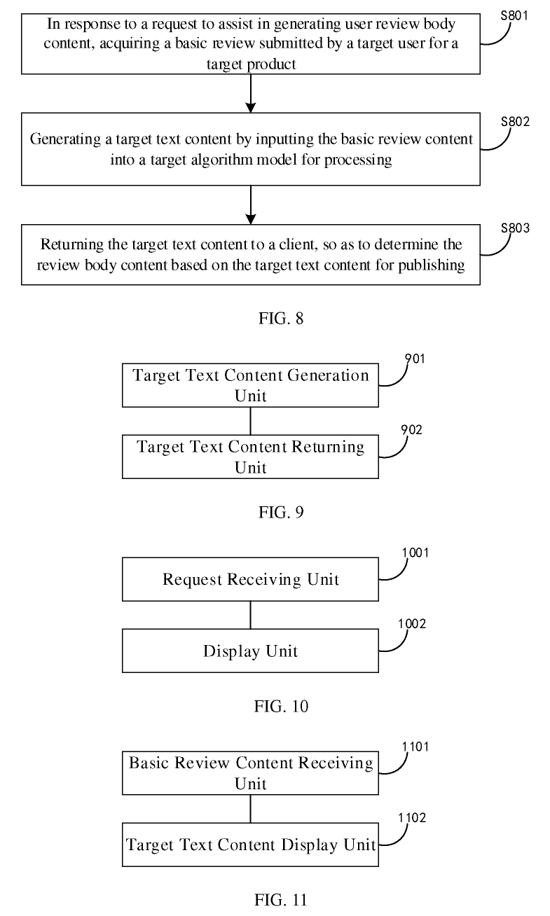

This Embodiment Four corresponds to Embodiment Three and provides a method for processing user review information of a product object from the perspective of a server. Referring to FIG. 8, the method may include:

S801: in response to a request to assist in generating user review body content, acquiring a basic review submitted by a target user for a target product.

S802: generating target text content by inputting the basic review into a target algorithm model for processing.

S803: returning the target text content to a client, so as to determine the review body content based on the target text content for publishing.

For the parts not detailed in the above Embodiment Four, reference can be made to the descriptions in Embodiment Three, which will not be repeated here.

It should be noted that embodiments of the present application may involve the use of user data. In practical applications, user-specific personal data may be used in the solutions described herein within the scope permitted by applicable laws and regulations, and in compliance with the requirements of applicable laws and regulations of the host country (for example, with explicit user consent, effective notification to the user, etc.).

Corresponding to Embodiment One, an embodiment of the present application also provides a device for processing user review information of a product object. Referring to FIG. 9, the device may include:

a target text content generation unit 901, configured to, in response to a request from a target user to view user reviews for a target product, generate target text content by inputting a plurality of user reviews associated with the target product into a target algorithm model for processing, where the target text content is used for providing a summarizing description of the plurality of user reviews; and

a target text content returning unit 902, configured to return the target text content to a client, so as to display the target text content when displaying the user review information.

Specifically, the target text content generation unit may be specifically configured to:

acquire sentiment type information expressed by the user reviews, information on advantages and disadvantages of the target product, information on commonalities or similarities existing between different user reviews, and/or matching relationship information between the target product and the needs/preferences of the target user, by inputting the plurality of user reviews associated with the target product into the target algorithm model for processing; and

generate the target text content by processing the acquired information.

In addition, the target text content generation unit may be specifically configured to:

generate the target text content by inputting the plurality of user reviews associated with the target product and personalized information of the target user into the target algorithm model for processing.

Corresponding to Embodiment Two, an embodiment of the present application also provides a device for processing user review information of a product object. Referring to FIG. 10, the device may include:

a request receiving unit 1001, configured to receive a request from a target user to view user reviews for a target product; and

a display unit 1002, configured to display a user review display page, where the user review display page includes target text content, the target text content is generated by inputting a plurality of user reviews associated with the target product into a target algorithm model for processing, and is used for providing a summarizing description of the plurality of user reviews.

The device may further include:

an interactive option providing unit, configured to, before displaying the target text content, provide an interactive option in the user review display page, so that a user can confirm whether to display the target text content, and trigger the display of the target text content after receiving a confirmation message.

Corresponding to Embodiment Three, an embodiment of the present application also provides a device for processing user review information of a product object. Referring to FIG. 11, the device may include:

a basic review receiving unit 1101, configured to, in response to a request initiated by a target user to fill in user review information for a target product object, acquire a basic review provided by the target user for the target product object; and

a target text content display unit 1102, configured to submit the basic review to a server, and acquire and display target text content, where the target text content is a text content generated by the server by inputting the basic review into a target algorithm model for processing, so as to determine review body content based on the target text content for publishing.

The basic review includes: sentiment type information expressed by the target user for the target product.

Alternatively, the basic review includes: rating information inputted or selected by the target user for the target product object through a plurality of rating items displayed in a user review editing interface.

The basic review may also include: review body content inputted by the target user for the target product through the user review editing interface.

In addition, the device may further include:

a refresh display unit, configured to, after the target text content is displayed, re-acquire and display a new target text content in response to a refresh request for the target text content.

a text usage unit, configured to, after the target text content is displayed, display the target text content in an input control for inputting the review body content in response to a request to use the target text content, so as to determine the review body content based on the target text content for publishing.

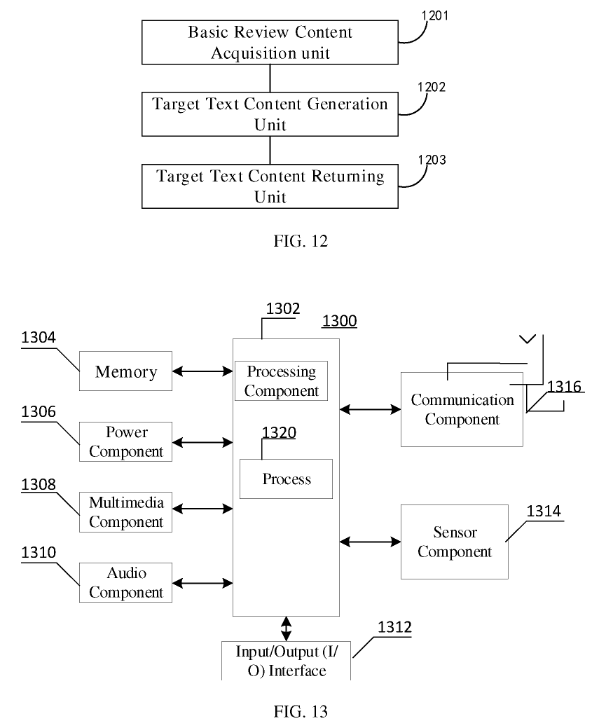

Corresponding to Embodiment Four, an embodiment of the present application also provides a device for processing user review information of a product object. Referring to FIG. 12, the device may include:

a basic review acquisition unit 1201, configured to, in response to a request to assist in generating user review body content, acquire basic review submitted by a target user for a target product;

a target text content generation unit 1202, configured to generate target text content by inputting the basic review into a target algorithm model for processing; and

a target text content returning unit 1203, configured to return the target text content to a client, so as to determine the review body content based on the target text content for publishing.

In addition, an embodiment of the present application also provides a computer-readable storage medium on which a computer program is stored, where the program, when executed by a processor, implements the steps of the method according to any one of the foregoing method embodiments.

And an electronic device, including:

one or more processors; and

a memory associated with the one or more processors, the memory being configured to store program instructions, where the program instructions, when read and executed by the one or more processors, execute the steps of the method according to any one of the foregoing method embodiments.

FIG. 13 exemplarily shows an architecture of an electronic device. For example, the device 1300 may be a mobile phone, a computer, a digital broadcast terminal, a messaging device, a game console, a tablet device, a medical device, a fitness device, a personal digital assistant, an aircraft, etc.

Referring to FIG. 13, the device 1300 may include one or more of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls the overall operations of the device 1300, such as operations associated with display, telephone calls, data communications, camera operations, and recording operations. The processing component 1302 may include one or more processors 1320 to execute instructions to complete all or part of the steps of the method provided by the technical solution of the present disclosure. In addition, the processing component 1302 may include one or more modules to facilitate interaction between the processing component 1302 and other components. For example, the processing component 1302 may include a multimedia module to facilitate interaction between the multimedia component 1308 and the processing component 1302.

The memory 1304 is configured to store various types of data to support operations on the device 1300. Examples of such data include instructions for any application or method operating on the device 1300, contact data, phonebook data, messages, pictures, videos, etc. The memory 1304 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The power component 1306 provides power to various components of the device 1300. The power component 1306 may include a power management system, one or more power sources, and other components associated with generating, managing, and distributing power for the device 1300.

The multimedia component 1308 includes a screen that provides an output interface between the device 1300 and a user. In some embodiments, the screen may include a liquid crystal display (LCD) and a touch panel (TP). If the screen includes a touch panel, the screen may be implemented as a touchscreen to receive input signals from the user. The touch panel includes one or more touch sensors to sense touches, swipes, and gestures on the touch panel. The touch sensors may not only sense the boundary of a touch or swipe action, but also detect the duration and pressure associated with the touch or swipe operation. In some embodiments, the multimedia component 1308 includes a front-facing camera and/or a rear-facing camera. When the device 1300 is in an operating mode, such as a shooting mode or a video mode, the front-facing camera and/or the rear-facing camera can receive external multimedia data. Each of the front-facing camera and the rear-facing camera may be a fixed optical lens system or have focal length and optical zoom capabilities.

The audio component 1310 is configured to output and/or input audio signals. For example, the audio component 1310 includes a microphone (MIC), which is configured to receive an external audio signal when the device 1300 is in an operating mode, such as a call mode, a recording mode, and a voice recognition mode. The received audio signal may be further stored in the memory 1304 or sent via the communication component 1316. In some embodiments, the audio component 1310 also includes a speaker for outputting audio signals.

The I/O interface 1312 provides an interface between the processing component 1302 and peripheral interface modules, where the aforementioned peripheral interface modules may be a keyboard, a click wheel, buttons, etc. These buttons may include, but are not limited to, a home button, a volume button, a start button, and a lock button.

The sensor component 1314 includes one or more sensors for providing status assessments of various aspects of the device 1300. For example, the sensor component 1314 can detect the open/closed state of the device 1300 and the relative positioning of components, for example, the components being the display and the keypad of the device 1300. The sensor component 1314 can also detect a change in position of the device 1300 or a component of the device 1300, the presence or absence of user contact with the device 1300, the orientation or acceleration/deceleration of the device 1300, and a change in temperature of the device 1300. The sensor component 1314 may include a proximity sensor configured to detect the presence of nearby objects without any physical contact. The sensor component 1314 may also include a light sensor, such as a CMOS or CCD image sensor, for use in imaging applications. In some embodiments, the sensor component 1314 may also include an acceleration sensor, a gyroscope sensor, a magnetic sensor, a pressure sensor, or a temperature sensor.

The communication component 1316 is configured to facilitate wired or wireless communication between the device 1300 and other devices. The device 1300 can access a wireless network based on communication standards, such as WiFi, or 2G, 3G, 4G/LTE, 5G and other mobile communication networks. In an exemplary embodiment, the communication component 1316 receives a broadcast signal or broadcast-related information from an external broadcast management system via a broadcast channel. In an exemplary embodiment, the communication component 1316 also includes a near field communication (NFC) module to facilitate short-range communication. For example, the NFC module may be implemented based on radio frequency identification (RFID) technology, Infrared Data Association (IrDA) technology, ultra-wideband (UWB) technology, Bluetooth (BT) technology, and other technologies.

In an exemplary embodiment, the device 1300 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components, for performing the above-described methods.

In an exemplary embodiment, there is also provided a non-transitory computer-readable storage medium including instructions, such as the memory 1304 including instructions, where the instructions are executable by the processor 1320 of the device 1300 to complete the method provided by the technical solution of the present disclosure. For example, the non-transitory computer-readable storage medium may be a ROM, a random access memory (RAM), a CD-ROM, a magnetic tape, a floppy disk, an optical data storage device, etc.

From the description of the above embodiments, a person skilled in the art can clearly understand that the present application can be implemented by means of software plus a necessary general hardware platform. Based on this understanding, the technical solution of the present application, in essence or the part that contributes to the prior art, can be embodied in the form of a software product. The computer software product can be stored in a storage medium, such as a ROM/RAM, a magnetic disk, an optical disc, etc., and includes several instructions to cause a computer device (which may be a personal computer, a server, or a network device, etc.) to execute the methods described in the various embodiments of the present application or certain parts of the embodiments.

The various embodiments in this specification are described in a progressive manner. The same or similar parts between the various embodiments can be referred to each other. Each embodiment focuses on describing the differences from other embodiments. In particular, for the system or system embodiments, since they are basically similar to the method embodiments, the description is relatively simple, and for relevant parts, reference can be made to the partial description of the method embodiments. The systems and system embodiments described above are merely illustrative. The units described as separate components may or may not be physically separate, and the components displayed as units may or may not be physical units, that is, they may be located in one place, or may be distributed over multiple network units. Some or all of the modules can be selected according to actual needs to achieve the objectives of the solutions of the embodiments. A person of ordinary skill in the art can understand and implement them without creative effort.

The foregoing has provided a detailed introduction to the method for processing user review information of a product object, and the electronic device provided by the present application. Specific examples have been used herein to explain the principles and implementation manners of the present application. The description of the above embodiments is only for helping to understand the method and its core ideas of the present application. At the same time, for a person of ordinary skill in the art, based on the ideas of the present application, the specific embodiments and application scope may be modified. In summary, the content of this specification should not be construed as a limitation on the present application.

1. A method for processing user review information of a product object, comprising:
in response to a request from a target user to view user reviews for a target product, generating target text content by inputting a plurality of user reviews associated with the target product into a target algorithm model for processing, wherein the target text content is used for providing a summarizing description of the plurality of user reviews; and
returning the target text content to a client, so as to display the target text content when displaying the user review information.

2. The method according to claim 1, wherein
generating the target text content by inputting the plurality of user reviews associated with the target product into the target algorithm model for processing comprises:
acquiring, by inputting the plurality of user reviews associated with the target product into the target algorithm model for processing, sentiment type information expressed by the user reviews, information on advantages and disadvantages of the target product, information on commonalities or similarities existing between different user reviews, and/or matching relationship information between the target product and needs/preferences of the target user; and
generating the target text content by processing the acquired information.

3. The method according to claim 1, wherein
generating the target text content by inputting the plurality of user reviews associated with the target product into the target algorithm model for processing comprises:
generating the target text content by inputting the plurality of user reviews associated with the target product and personalized information of the target user into the target algorithm model for processing.

4. The method according to claim 1, further comprising:
displaying the target text content in a user review display page.

5. The method according to claim 4, further comprising:
before displaying the target text content, providing an interactive option in the user review display page, so that a user can confirm whether to display the target text content, and triggering a display of the target text content after receiving a confirmation message.

6. A non-transitory computer-readable storage medium configured with instructions executable by one or more processors to cause the one or more processors to perform the method of claim 1.

7. An electronic device comprising:
one or more processors; and
one or more computer-readable memories coupled to the one or more processors and having instructions stored thereon that are executable by the one or more processors to perform the method of claim 1.

8. A method for processing user review information of a product object, comprising:
in response to a request initiated by a target user to fill in user review information for a target product object, acquiring a basic review provided by the target user for the target product object; and
submitting the basic review to a server, and acquiring and displaying target text content, wherein the target text content is text content generated by the server by inputting the basic review into a target algorithm model for processing, so as to determine review body content based on the target text content for publishing.

9. The method according to claim 8, wherein the basic review comprises: sentiment type information expressed by the target user for the target product.

10. The method according to claim 8, wherein the basic review comprises: rating information inputted or selected by the target user for the target product object through a plurality of rating items displayed in a user review editing interface.

11. The method according to claim 8, wherein the basic review further comprises: review body content inputted by the target user for the target product through a user review editing interface.

12. The method according to claim 8, further comprising:
after displaying the target text content, re-acquiring and displaying new target text content in response to a refresh request for the target text content.

13. The method according to claim 8, further comprising:
after displaying the target text content, displaying the target text content in an input control for inputting review body content in response to a request to use the target text content, so as to determine the review body content based on the target text content for publishing.

14. A non-transitory computer-readable storage medium configured with instructions executable by one or more processors to cause the one or more processors to perform the method of claim 8.

15. An electronic device comprising:
one or more processors; and
one or more computer-readable memories coupled to the one or more processors and having instructions stored thereon that are executable by the one or more processors to perform the method of claim 8.

16. An apparatus for processing user review information of a product object, comprising:
a target text content generation unit configured to, in response to a request from a target user to view user reviews for a target product, generate target text content by inputting a plurality of user reviews associated with the target product into a target algorithm model for processing, wherein the target text content is used for providing a summarizing description of the plurality of user reviews; and
a target text content returning unit configured to return the target text content to a client, so as to display the target text content when displaying the user review information.

17. The apparatus according to claim 16, wherein
to generate target text content by inputting a plurality of user reviews associated with the target product into a target algorithm model for processing, the target text content generation unit is further configured to:
acquire, by inputting the plurality of user reviews associated with the target product into the target algorithm model for processing, sentiment type information expressed by the user reviews, information on advantages and disadvantages of the target product, information on commonalities or similarities existing between different user reviews, and/or matching relationship information between the target product and needs/preferences of the target user; and
generate the target text content by processing the acquired information.

18. The apparatus according to claim 16, wherein
to generate the target text content by inputting the plurality of user reviews associated with the target product into the target algorithm model for processing, the target text content generation unit is further configured to:
generate the target text content by inputting the plurality of user reviews associated with the target product and personalized information of the target user into the target algorithm model for processing.
